(19) United States
(12) Patent Application Publication
(10) Pub. No.: US 2014/0145959 A1
(43) Pub. Date: May 29, 2014

(54) INFORMATION PROCESSING APPARATUS, EXTENSION DEVICE, AND INPUT CONTROL METHOD

(71) Applicant: Kabushiki Kaisha Toshiba, Tokyo (JP)

(72) Inventor: Tetsuo Hatakeyama, Tokyo (JP)

(73) Assignee: Kabushiki Kaisha Toshiba, Tokyo (JP)

(21) Appl. No.: 14/010,303

(22) Filed: Aug. 26, 2013

(30) Foreign Application Priority Data
Nov. 29, 2012 (JP) 2012-261257

(51) Int. Cl. G06F 3/03

(52) U.S. Cl. CPC G06F 3/0304
USPC 345/168; 345/175

(57) ABSTRACT

According to one embodiment, an information processing apparatus includes a main body having a display screen and an extension device. The extension device includes a detector. The detector is configured to detect an operation with an operating part performed on a virtual operating surface and output detection information on the operation. The virtual operating surface is a virtual plane spaced apart from the display screen by a predetermined distance. The main body includes a connection detector, a virtual input module, and an input controller. The virtual input module is configured to receive the detection information from the extension device and determine a position of the operating part on the virtual operating surface based on the detection information. The input controller is configured to perform input processing as a touch operation at the position having been determined.

### CROSS-REFERENCE TO RELATED APPLICATIONS

This application is based upon and claims the benefit of priority from Japanese Patent Application No. 2012-261257, filed Nov. 29, 2012, the entire contents of which are incorporated herein by reference.

### FIELD

Embodiments described herein relate generally to an information processing apparatus, an extension device, and an input control method.

### BACKGROUND

Conventionally, there has been known a tablet type information processing apparatus provided with a touch screen on the front side thereof and allows attaching and detaching of a keyboard. In such an information processing apparatus, touch operations can be performed on the touch screen with the keyboard being connected.

In such a conventional technique, however, when a user performs a touch operation on the touch screen, the contact of a finger of the user with the touch screen shakes the information processing apparatus, making it hard to perform an intended touch operation.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram schematically illustrating the appearance of an information processing apparatus according to a first embodiment;

FIG. 2 is an exemplary diagram illustrating the relation between a touch screen and a virtual operating surface;

FIG. 3 is an exemplary diagram illustrating an example of the hardware configuration of an extension device of the information processing apparatus;

FIG. 4 is an exemplary diagram for describing that distance image sensors detect a finger of a user on the virtual operating surface;

FIG. 5 is an exemplary diagram illustrating an example of the hardware configuration of a main body of the information processing apparatus;

FIG. 6 is an exemplary block diagram illustrating the functional configuration of the main body in the first embodiment;

FIG. 7 is an exemplary diagram for describing the calculations of the sectional area and pressing force of a finger of a user crossing the virtual operating surface;

FIG. 8 is an exemplary flowchart illustrating the procedure of input control processing in the first embodiment;

FIG. 9 is an exemplary block diagram illustrating the functional configuration of an extension device according to a second embodiment;

FIG. 10 is an exemplary block diagram illustrating the functional configuration of a main body in the second embodiment;

FIG. 11 is an exemplary flowchart illustrating the procedure of input control processing in the second embodiment;

FIG. 12 is an exemplary diagram schematically illustrating the appearance of an information processing apparatus according to a third embodiment;

FIG. 13 is an exemplary block diagram illustrating the functional configuration of an information processing apparatus 1200 in the third embodiment; and

FIG. 14 is an exemplary flowchart illustrating the procedure of input control processing in the third embodiment.

### DETAILED DESCRIPTION

In general, according to one embodiment, an information processing apparatus includes a main body having a display screen and an extension device. The extension device is configured to be connectable with the main body. The extension device includes a detector. The detector is configured to detect an operation with an operating part performed on a virtual operating surface and output detection information on the operation. The virtual operating surface is a virtual plane spaced apart from the display screen by a predetermined distance. The main body includes a connection detector, a virtual input module, and an input controller. The connection detector is configured to detect connection of the extension device. The virtual input module is configured to receive the detection information from the extension device when the connection of the extension device has been detected and determine a position of the operating part on the virtual operating surface based on the detection information. The input controller is configured to perform input processing as a touch operation at the position having been determined.

### First Embodiment

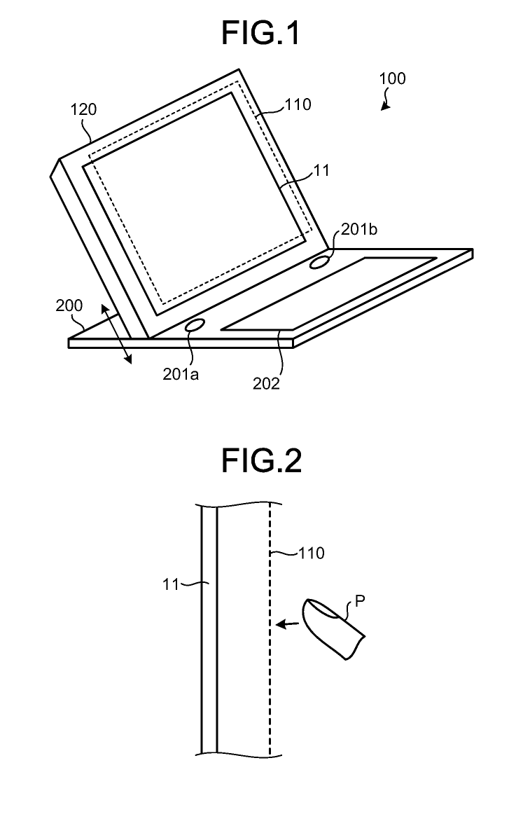

An information processing apparatus 100 according to the present embodiment comprises a main body 120 and an extension device 200 as illustrated in FIG. 1. The main body 120 is developed as a slate terminal (a tablet terminal), an electronic book reader, or the like.

The main body 120 comprises a touch screen 11 that serves as a display screen and allows inputting through touch operations by a user. In the present embodiment, a virtual operating surface 110 is spaced apart from the touch screen 11 by a predetermined distance.

As illustrated in FIG. 2, the virtual operating surface 110 is a surface nearly parallel to the touch screen 11 spaced apart from the touch screen 11 by the predetermined distance, for example, a few centimeters. In the present embodiment, the user performs an operation on the virtual operating surface 110 with a finger P or stylus pen (an operating part) in a noncontact manner with the touch screen 11. Such an operation is input as an operation equivalent to a touch operation on the touch screen 11.

Returning to FIG. 1, the extension device 200 is mechanically attachable to and detachable from the main body 120. FIG. 1 illustrates a state in which the extension device 200 is connected to the main body 120. As illustrated in FIG. 1, the extension device 200 comprises a keyboard 202 and two distance image sensors 201a and 201b. The details of the components will be described later.

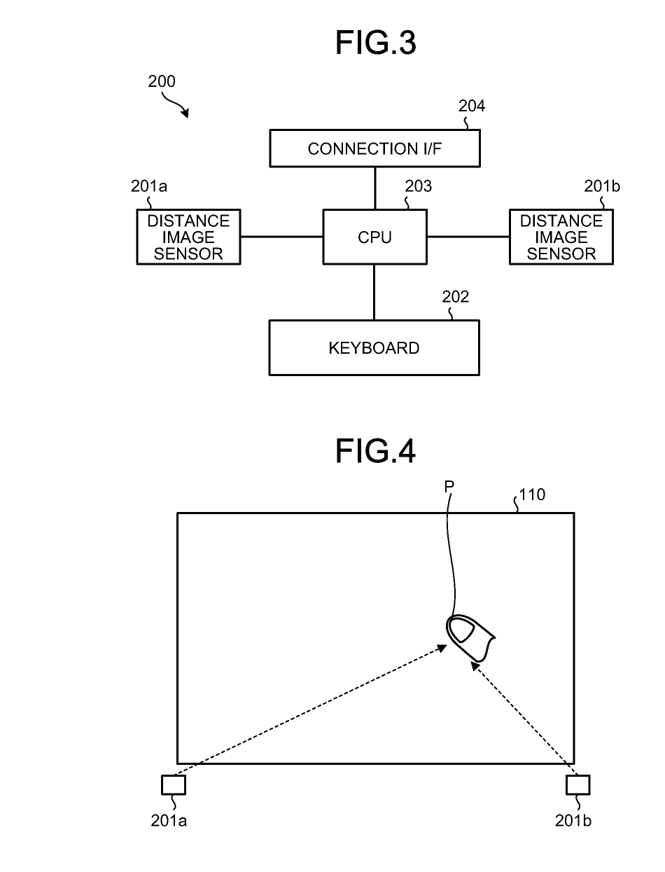

As illustrated in FIG. 3, the extension device 200 comprises, as a hardware configuration, a CPU 203, a connection I/F 204, the keyboard 202, and the two distance image sensors 201a and 201b.

The CPU 203 is a processor that controls the operation of the extension device 200. The connection I/F 204 is an interface to which the main body 120 is connected. The keyboard 202 receives key operations from the user. The main body 120 is informed of the key operations as key events.

The distance image sensors 201a and 201b measure the distance to a three-dimensional object using infrared rays in a noncontact manner and are used for the measurement of shapes and dimensions in a noncontact manner. In the present embodiment, as illustrated in FIG. 1, the distance image sensors 201a and 201b are arranged in the vicinity of the ends at the base of the main body 120 when the main body 120 is connected and emit infrared rays with an angle with which the distance image sensors 201a and 201b can detect an operation on the virtual operating surface 110 and receive the reflected waves thereof.

As illustrated in FIG. 4, each of the distance image sensors 201a and 201b detects the finger P of the user on the virtual operating surface 110 at constant time intervals and outputs each sensor data indicating the distance to the finger P to the CPU 203 in succession. The CPU 203 transmits each sensor data output in succession from the respective distance image sensors 201a and 201b to the main body 120.

In the present embodiment, as is the case with multi-touch to the touch screen 11, a plurality of operations can be simultaneously performed on the virtual operating surface 110 through a plurality of operating parts such as the finger P. In this case, with only one distance image sensor, one finger would forma blind spot in which another finger would be hidden, thereby impairing detection by the distance image sensor. In the present embodiment, for this reason, the two distance image sensors 201a and 201b are provided to avoid an operation detection failure caused by the blind spot. The number of the distance image sensors 201a and 201b may not be limited to two and may be three or more.

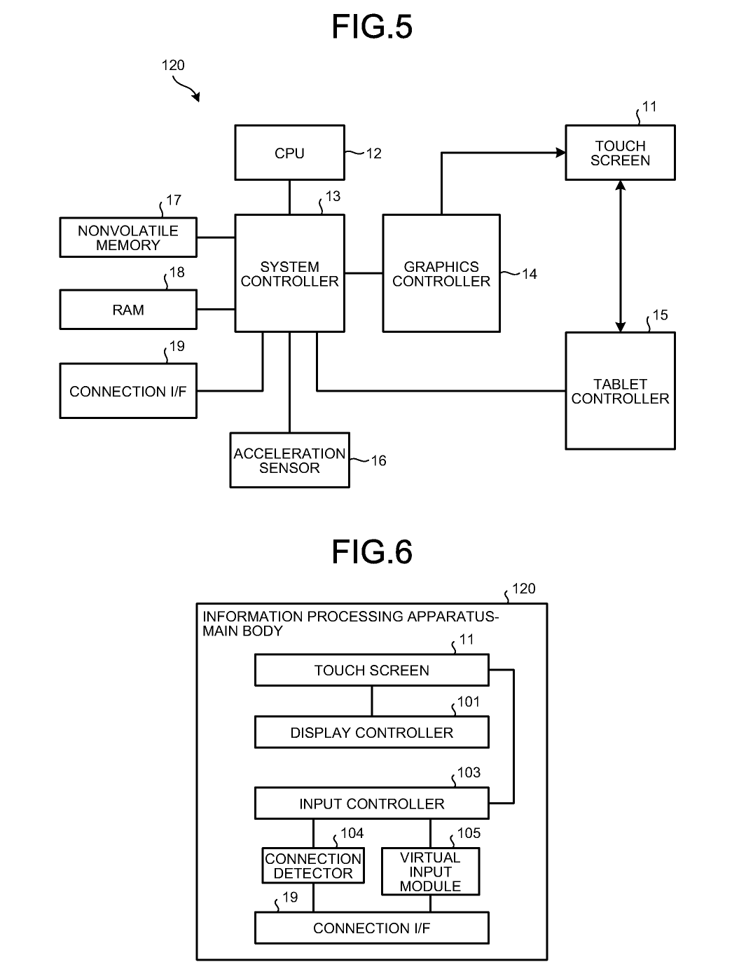

Next, the main body 120 of the information processing apparatus 100 will be described. As illustrated in FIG. 5, the main body 120 comprises, as the hardware configuration, in addition to the above-described touch screen 11, a CPU 12, a system controller 13, a graphics controller 14, a tablet controller 15, an acceleration sensor 16, a connection I/F 19, a nonvolatile memory 17, and a RAM 18.

The touch screen 11 severs as the display screen, and as described above, can detect a position on the display screen touched by a finger of the user (a touch position).

The CPU 12 is a processor for controlling the operation of the information processing apparatus 100. The CPU 12 controls the components of the information processing apparatus 100 via the system controller 13. The CPU 12 runs an operating system and various types of application programs loaded into the RAM 18 from the nonvolatile memory 17, thereby implementing each functional module that will be described later (see FIG. 6). The RAM 18 functions as a main memory of the information processing apparatus 100.

The system controller 13 also incorporates a memory controller that performs access control on the nonvolatile memory 17 and the RAM 18. The system controller 13 also has a function of performing communications with the graphics controller 14.

The graphics controller 14 is a display controller that controls the touch screen 11 used as a display monitor of the information processing apparatus 100. The tablet controller 15 acquires coordinate data indicating a position on the touch screen 11 touched by the user from the touch screen 11.

The acceleration sensor 16 is, for example, an acceleration sensor for three-axis directions (X, Y, and Z directions) or six-axis directions in which detection in the rotational direction about each axis is added to the three-axis directions. The acceleration sensor 16 detects the direction and magnitude of external acceleration exerted on the information processing apparatus 100 and outputs them to the CPU 12. Specifically, the acceleration sensor 16 outputs an acceleration detection signal containing information on the axis through which the acceleration has been detected, the direction (or rotational angle for rotation), and the magnitude thereof to the CPU 12. The acceleration sensor 16 may be integrated with a gyro sensor for detection of angular velocity (rotational angle). The connection I/F 19 is an interface to which the extension device 200 is connected.

The main body 120 of the information processing apparatus 100 comprises mainly, as a functional configuration, the above-described touch screen 11 and the connection I/F 19, a display controller 101, an input controller 103, a connection detector 104, and a virtual input module 105 as illustrated in FIG. 6. FIG. 6 illustrates only a processing module that is necessary for an input-output function according to the present embodiment.

The display controller 101 controls various types of displays on the touch screen 11. The connection detector 104 detects via the connection I/F 19 whether the extension device 200 is connected.

The virtual input module 105 successively inputs, through the extension device 200, the sensor data output from the distance image sensors 201a and 201b of the extension device 200, when the connection of the extension device 200 has been detected by the connection detector 104. The virtual input module 105 determines the position coordinates on the virtual operating surface 110 of the finger P of the user that has performed an operation on the virtual operating surface 110 from the data of distance indicated by a plurality of pieces of sensor data.

When each sensor data input in succession continuously indicates a distance being in contact with the virtual operating surface 110, the virtual input module 105 measures the time and sets the time as a contact time for which the finger P of the user is in contact with the virtual operating surface 110.

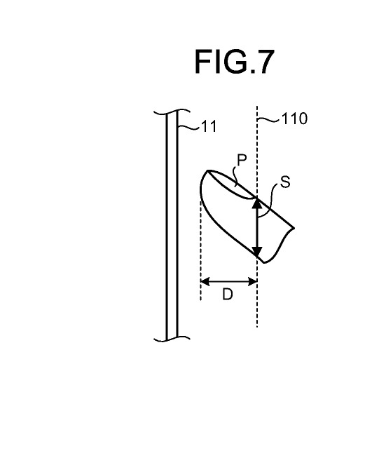

The virtual input module 105 determines the spatial position of the finger P of the user with respect to the virtual operating surface 110 from each sensor data input in succession. From the spatial position, as illustrated in FIG. 7, the virtual input module 105 calculates a sectional area S on the virtual operating surface 110 of the finger P of the user crossing the virtual operating surface 110 as a contact area on the virtual operating surface 110.

From the spatial position of the finger P determined as described above, as illustrated in FIG. 7, the virtual input module 105 then calculates a depth D from the virtual operating surface 110 of the finger P of the user crossing the virtual operating surface 110 and calculates a pressing force on the virtual operating surface 110 based on the depth D. More specifically, the virtual input module 105 calculates the pressing force proportional to the depth D.

The virtual input module 105 transmits the position coordinates of the finger P on the virtual operating surface 110, the contact time of the finger P on the virtual operating surface 110, the contact area of the finger P on the virtual operating surface 110, and the pressing force of the finger P on the virtual operating surface 110 that have been calculated to the input controller 103.

The input controller 103 receives the inputting of key events from the keyboard 202 included in the extension device 200 and connected via the connection I/F, and touch input from the touch screen 11. The touch input includes the position coordinate of a touch operation, the contact time of a touch operation, the contact area of a touch operation, and the pressing force of a touch operation on the touch screen.

The input controller 103 performs input processing on an operation by the finger P of the user on the virtual operating surface 110 that has been input through the virtual input module 105, as a touch operation. In other words, the input controller 103 handles the position coordinates of the finger on the virtual operating surface 110, the contact time of the finger P on the virtual operating surface 110, the contact area of the finger P on the virtual operating surface 110, and the pressing force of the finger P on the virtual operating surface 110 that have been input from the virtual input module 105, as the position coordinates of the touch operation, the contact time of the touch operation, the contact area of the touch operation, and the pressing force of the touch operation on the touch screen, respectively, in the same manner as the touch operation, to perform input processing.

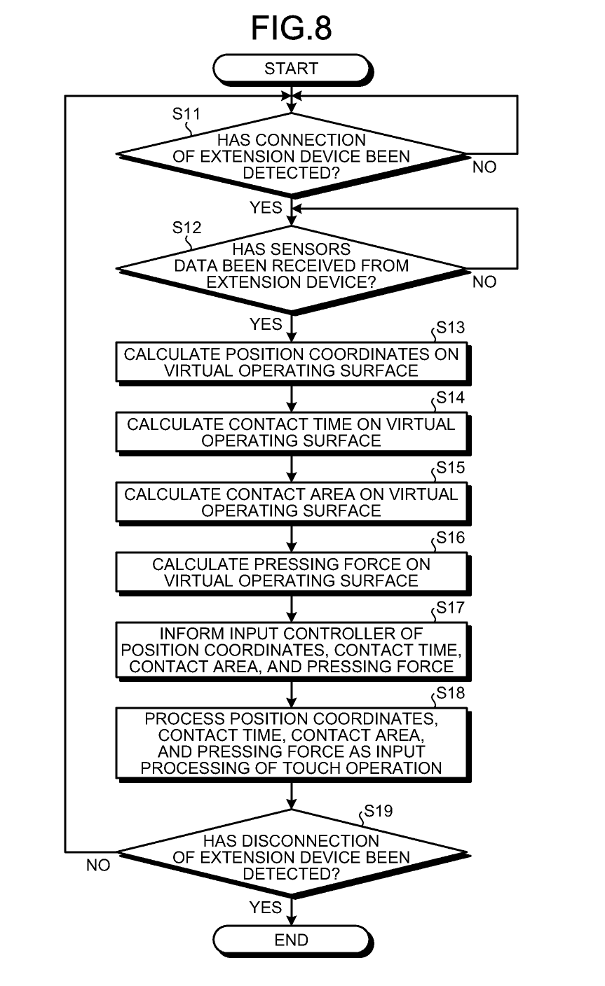

Next, using FIG. 8, described will be input control processing performed through the main body 120 thus configured of the information processing apparatus 100 of the present embodiment. It is supposed here that the extension device 200 is connected to the main body 120 and that the user is performing operations on the virtual operating surface 110 with the finger P.

First, the connection detector 104 of the main body 120 determines the connection detection of the extension device 200 (S11). When the connection detector 104 detects the connection of the extension device 200 (Yes at S11), the virtual input module 105 enters a state of waiting for sensor data from the extension device 200 (S12, No at S12).

When the virtual input module 105 receives sensor data from the extension device 200 (Yes at S12), the virtual input module 105 calculates the position coordinates of the finger P of the user on the virtual operating surface 110 from the sensor data received in succession (S13).

Next, the virtual input module 105, as described above, calculates the contact time of the finger P of the user on the virtual operating surface 110 from the sensor data received in succession (S14). The virtual input module 105, as described above, then calculates the contact area of the finger P of the user on the virtual operating surface 110 from the sensor data received in succession (S15). The virtual input module 105, as described above, then calculates the pressing force on the virtual operating surface 110 from the depth D of the finger P of the user from the virtual operating surface 110, from the sensor data received in succession (S16). The virtual input module 105 then informs the input controller 103 of the position coordinates, contact time, contact area, and pressing force on the virtual operating surface 110 that have been calculated (S17).

Next, the input controller 103 processes the position coordinates, contact time, contact area, and pressing force on the virtual operating surface 110 that have been received from the virtual input module 105, as the inputting of the touch operation (S18).

The connection detector 104 then determines whether the disconnection of the extension device 200 has been detected (S19). When the disconnection of the extension device 200 has not been detected (No at S19), the pieces of processing from S11 to S18 are repeated.

When the disconnection of the extension device 200 has been detected (Yes at S19), the processing is ended.

In the present embodiment, as described above, the user performs an operation on the virtual operating surface 110 spaced apart from the touch screen 11 by a predetermined distance in a noncontact manner with the touch screen 11. The operation is detected by the distance image sensors 201a and 201b of the extension device 200 and is handled on the main body 120 side as an operation equivalent to a touch operation on the touch screen 11 to be subjected to input processing. The present embodiment therefore can avoid shakes of the information processing apparatus caused by the touch operation, thereby achieving the operation intended by the user.

### Second Embodiment

In the first embodiment, the calculations of position coordinates, contact time, contact area, and pressing force from an operation on the virtual operating surface 110 are performed on the main body 120 side. In this second embodiment, the calculations of position coordinates, contact time, contact area, and pressing force are performed on the extension device side.

The hardware configurations of a main body 1020 and an extension device 900 of the information processing apparatus 100 of the second embodiment are similar to those of the first embodiment.

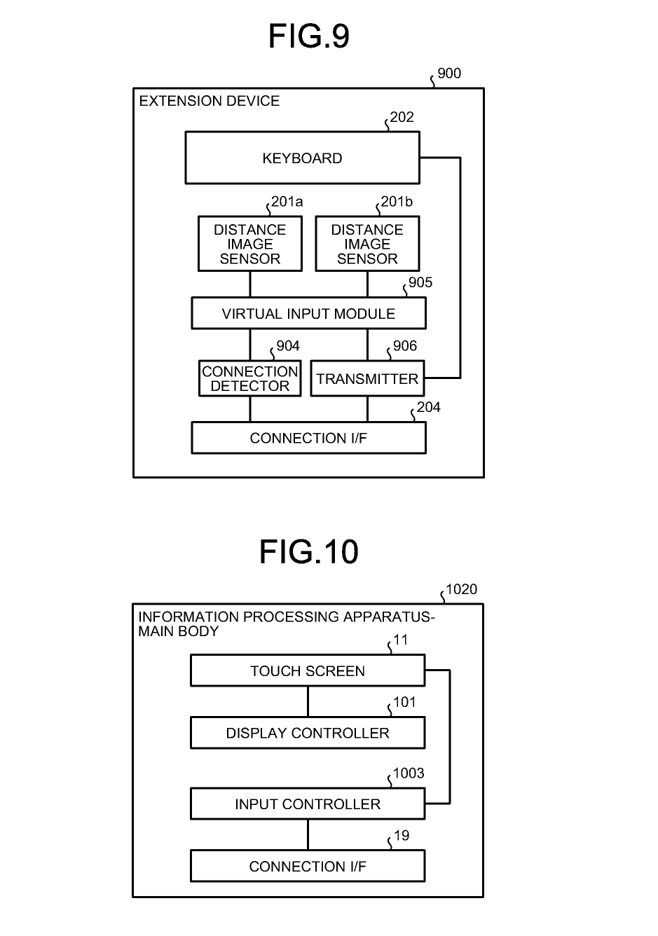

The extension device 900 of the present embodiment comprises mainly, as illustrated in FIG. 9, the keyboard 202, the distance image sensors 201a and 201b, a virtual input module 905, a connection detector 904, a transmitter 906, and the connection I/F 204. The keyboard 202, the distance image sensors 201a and 201b, and the connection I/F 204 are similar to those of the first embodiment.

The connection detector 904 detects via the connection I/F 204 whether the main body 1020 is connected.

The virtual input module 905 has a function equivalent to that of the virtual input module 105 of the main body 120 of the first embodiment. In other words, when the connection of the main body 1020 has been detected by the connection detector 904, the virtual input module 905 successively inputs the sensor data output from the distance image sensors 201a and 201b and determines the position coordinates on the virtual operating surface 110 of the finger P of the user that has performed an operation on the virtual operating surface 110.

When each sensor data input in succession continuously indicates a distance being in contact with the virtual operating surface 110, the virtual input module 905 measures the time and sets the time as the contact time for which the finger P of the user is in contact with the virtual operating surface 110.

The virtual input module 905, as is the case with the first embodiment, calculates a sectional area S on the virtual operating surface 110 of the finger P of the user crossing the virtual operating surface 110 as the contact area on the virtual operating surface 110 from each sensor data input in succession.

The virtual input module 905, as is the case with the first embodiment, calculates the depth D from the virtual operating surface 110 of the finger P of the user crossing the virtual operating surface 110 and calculates a pressing force proportional to the depth D.

The virtual input module 905 transmits the position coordinates of the finger P on the virtual operating surface 110, the contact time of the finger P on the virtual operating surface 110, the contact area of the finger P on the virtual operating surface 110, and the pressing force of the finger P on the virtual operating surface 110 that have been calculated to the transmitter 906.

The transmitter 906 transmits the position coordinates of the finger P on the virtual operating surface 110, the contact time of the finger P on the virtual operating surface 110, the contact area of the finger P on the virtual operating surface 110, and the pressing force of the finger P on the virtual operating surface 110 that have been received from the virtual input module 905 to the main body 1020.

The main body 1020 of the information processing apparatus 100 of the present embodiment comprises mainly, as a functional configuration, as illustrated in FIG. 10, the touch screen 11, the connection I/F 19, the display controller 101, and an input controller 1003. The touch screen 11, the connection I/F 19, and the display controller 101 have functions similar to those of the first embodiment. In the present embodiment, functions corresponding to the connection detector 104 and the virtual input module 105 in the first embodiment are provided in the extension device 900.

The input controller 1003, as is the case with the first embodiment, receives the inputting of key events from the keyboard 202 included in the extension device 900 and connected via the connection I/F, and touch input from the touch screen 11.

The input controller 1003 performs input processing on an operation by the finger P of the user on the virtual operating surface 110 that has been input through the virtual input module 905 of the extension device 900, as a touch operation. In other words, the input controller 1003 receives, from the extension device 900, the position coordinates of the finger on the virtual operating surface 110, the contact time of the finger P on the virtual operating surface 110, the contact area of the finger P on the virtual operating surface 110, and the pressing force of the finger P on the virtual operating surface 110. The input controller 1003 handles the position coordinates of the finger on the virtual operating surface 110, the contact time of the finger P on the virtual operating surface 110, the contact area of the finger P on the virtual operating surface 110, and the pressing force of the finger P on the virtual operating surface 110 that have been input from the virtual input module 105, as the position coordinates of the touch operation, the contact time of the touch operation, the contact area of the touch operation, and the pressing force of the touch operation on the touch screen, respectively, in the same manner as the touch operation, to perform input processing.

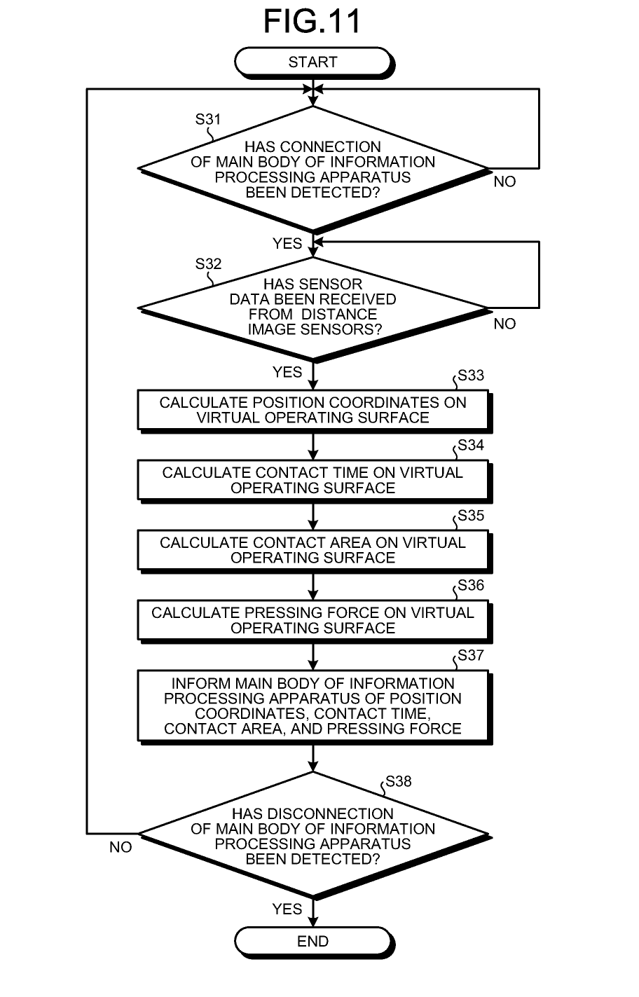

Next, using FIG. 11, described will be input control processing performed through the thus configured extension device 900 of the information processing apparatus 100 of the present embodiment. It is supposed here that the extension device 900 is connected to the main body 1020 and that the user is performing operations on the virtual operating surface 110 with the finger P.

First, the connection detector 904 of the extension device 900 determines the connection detection of the main body 1020 (S31). When the connection detector 904 detects the connection of the main body 1020 (Yes at S31), the virtual input module 905 enters a state of waiting for sensor data from the distance image sensors 201a and 201b (S32, No at S32).

When the virtual input module 905 receives sensor data from the distance image sensors 201a and 201b (Yes at S32), the virtual input module 905 calculates the position coordinates of the finger P of the user on the virtual operating surface 110 from the sensor data received in succession (S33).

Next, the virtual input module 905 calculates the contact time of the finger P of the user on the virtual operating surface 110 from the sensor data received in succession (S34). The virtual input module 905 then calculates the contact area of the finger P of the user on the virtual operating surface 110 from the sensor data received in succession (S35). The virtual input module 905 then calculates the pressing force on the virtual operating surface 110 from the depth D of the finger P of the user from the virtual operating surface 110 (S36).

The transmitter 906 then transmits the position coordinates, contact time, contact area, and pressing force on the virtual operating surface 110 that have been calculated to the main body 1020 (S37). The input controller 1003 of the main body 1020 thereby processes the position coordinates, contact time, contact area, and pressing force that have been received from the extension device 900, as the inputting of the touch operation.

The connection detector 904 then determines whether the disconnection of the main body 1020 has been detected (S38). When the disconnection of the main body 1020 has not been detected (No at S38), the pieces of processing from S31 to S37 are repeated.

When the disconnection of the main body 1020 has been detected (Yes at S38), the processing is ended.

In the present embodiment, as described above, the user performs an operation on the virtual operating surface 110 spaced apart from the touch screen 11 by a predetermined distance in a noncontact manner with the touch screen 11. The operation is detected by the distance image sensors 201a and 201b of the extension device 900, is converted on the extension device 900 side into an operation equivalent to a touch operation on the touch screen 11, and is transmitted to the main body 1020 side to be subjected to input processing. The present embodiment therefore can achieve the same effect as the first embodiment, and in addition, reduce processing load on the main body 1020 side.

### Third Embodiment

The first embodiment has exemplified a configuration in which the extension device 200 provided with the keyboard is detachable from the main body 120 of the information processing apparatus 100. In this third embodiment, a housing mounted with a keyboard or the like and a housing mounted with the touch screen 11 are mechanically connected in an undetachable manner.

Specifically, an information processing apparatus of the present embodiment comprises a first housing and a second housing connected to the first housing and provided with a display screen. The first housing comprises a detector. The detector is configured to detect an operation performed with an operating part on a virtual operating surface and output detection information on the operation. The virtual operating surface is a virtual plane spaced apart from the display screen by a predetermined distance. The second housing comprises a connection detector, a virtual input module, and an input controller. The connection detector is configured to detect the connection of the first housing. The virtual input module is configured to input the detection information on the operation from the first housing when the connection of the first housing has been detected and determine a position of the operating part on the virtual operating surface based on the detection information on the operation. The input controller is configured to perform input processing as a touch operation at the position having been determined.

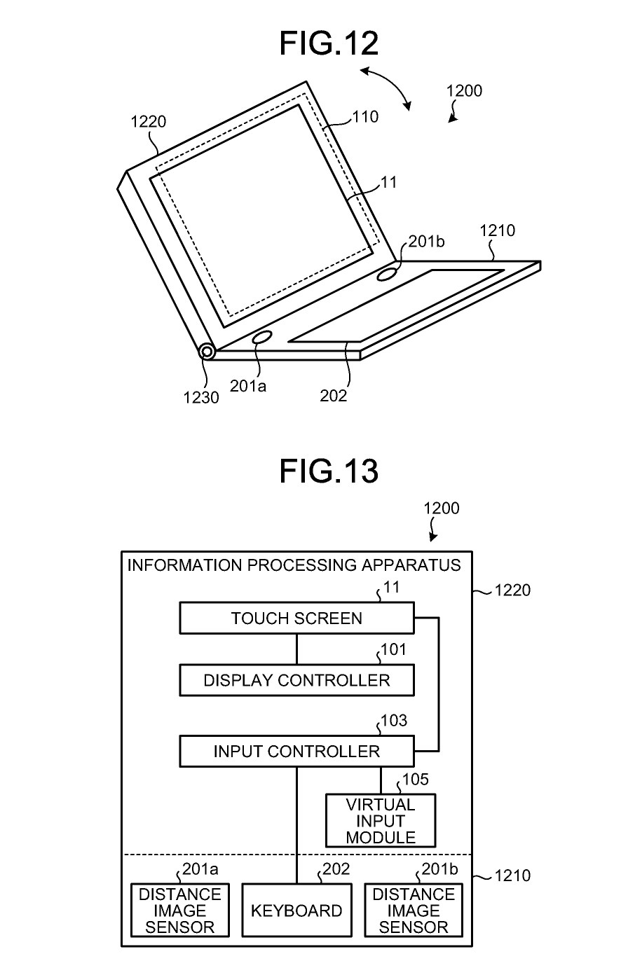

This information processing apparatus 1200 of the present embodiment is, as illustrated in FIG. 12, shaped in a clamshell form, in which two plate-shaped housings 1210 and 1220 are connected in a pivotally movable manner with each other. The first housing 1210 and the second housing 1220 are connected through a hinge mechanism 1230 to be undetachable. The housings are pivotally movable with respect to each other between a closed state with the angle between them being 0 degree and an open state with a maximum angle (for example, 120 degrees).

The housing 1220 (hereinafter referred to as the second housing 1220) is provided with the touch screen 11, as is the case with the main body 120 in the first embodiment. Considered is a touch operation on the virtual operating surface 110 spaced apart from the touch screen by a predetermined distance.

The housing 1210 (hereinafter referred to as the first housing 1210) is provided with the two distance image sensors 201a and 201b and the keyboard 202, as is the case with the extension device 200 in the first embodiment.

The two distance image sensors 201a and 201b of the first housing 1210 are arranged in the vicinity of the ends of a connecting part between the second housing 1220 and the first housing 1210. Even when the angle between the second housing 1220 and the first housing 1210 becomes the largest angle, they emit infrared rays with an angle with which the distance image sensors 201a and 201b can detect an operation on the virtual operating surface 110 and receive the reflected waves thereof.

The functions of the two distance image sensors 201a and 201b, the keyboard 202, and the touch screen 11 and the role of the virtual operating surface 110 are similar to those of the first embodiment. The hardware configuration of the information processing apparatus 1200 of the present embodiment is also similar to that of the first embodiment.

The information processing apparatus 1200 of the present embodiment comprises mainly, as a functional configuration, as illustrated in FIG. 13, in addition to the above-described touch screen 11, two distance image sensors 201a and 201b, the keyboard 202, the display controller 101, the input controller 103, and the virtual input module 105. The functions of the display controller 101, the input controller 103, and the virtual input module 105 are similar to those of the respective modules of the main body 120 of the first embodiment. In the present embodiment, the first housing 1210 and the second housing 1220 are mechanically connected. Thus, the connection detector and the connection I/F are not provided.

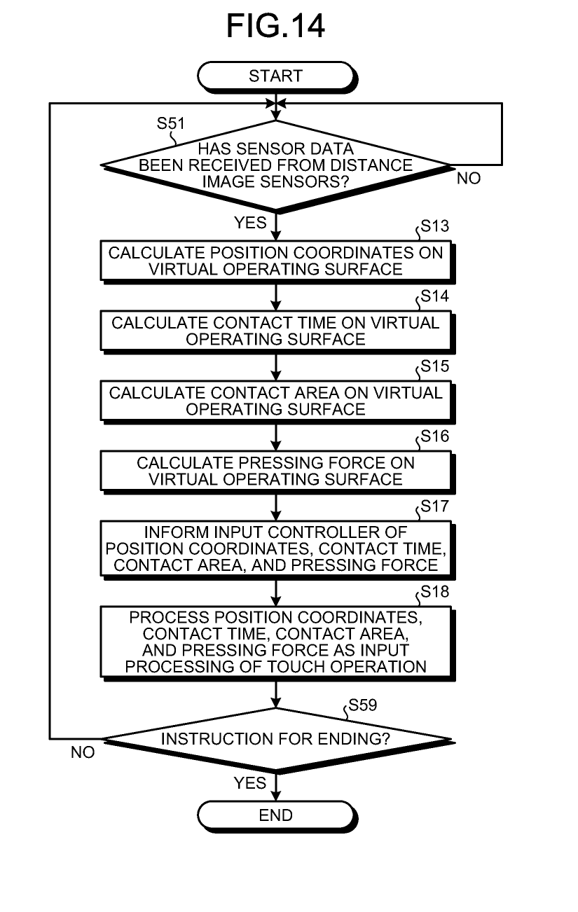

Next, using FIG. 14, described will be input control processing by the information processing apparatus 1200 thus configured of the present embodiment.

The virtual input module 105 is in wait for the reception of sensor data from the distance image sensors 201a and 201b (S51, No at S51). The following pieces of processing from S13 to S18 are performed in the similar manner as the first embodiment.

At S18, the input controller 103 processes the position coordinates, contact time, contact area, and pressing form that have been received from the virtual input module 105, as the inputting of a touch operation. Subsequently, the input controller 103 determines whether an instruction for ending has been received from the user (S59).

When the instruction for ending has not yet been received (No at S59), the pieces of processing from S51 to S18 are repeated. When the instruction for ending has been received (Yes at S59), the processing is ended.

In the present embodiment, as described above, when the housing mounted with the keyboard or the like and the housing mounted with the touch screen 11 are mechanically connected, the user performs an operation on the virtual operating surface 110 spaced apart from the touch screen 11 by a predetermined distance in a noncontact manner with the virtual operating surface 110. The operation is detected by the distance image sensors 201a and 201b of the first housing 1210 and is handled as an operation equivalent to a touch operation on the touch screen 11 to be subjected to input processing. In the present embodiment, therefore, the information processing apparatus 1200 connected with the two housings can avoid shakes of the information processing apparatus caused by touch the operation, thereby achieving the operation intended by the user.

Although the present embodiment has exemplified the clamshell-shaped information processing apparatus 1200, in which the two housings are undetachable and are connected in a pivotally movable manner, this is not a limited example. For example, also embodied can be a keyboard-equipped tablet that transforms so that two housings are overlapped, and a keyboard of the connected housings is housed or moved to the backside.

For example, the above-described first and second embodiments are configured so that the extension devices 200 and 900 are provided as the keyboard, and the third embodiment is configured so that the information processing apparatus 1200 is provided with the keyboard. These are, however, not limited configurations, as long as a sensor that can detect an operation on the virtual operating surface 110 is provided. For example, a cradle or the like that supports the main bodies 120 and 1020 without a keyboard may be used as an extension device, or the information processing apparatus 1200 may be configured without the keyboard in the first housing 1210.

Although in the above-described first to third embodiments, the distance image sensors 201a and 201b are used as the detector for detecting an operation on the virtual operating surface 110, these are not limited examples. For example, any module including an image capture camera and an image sensor can be used as the detector, as long as it detects an operation on the virtual operating surface 110. In this case, the virtual input modules 105 and 905 may be configured so that the position, contact time, contact area, depth, and the like of the finger P of the user are determined by analyzing a captured image.

Although the above-described first and second embodiments are configured so that the main bodies 120 and 1020 and the extension devices 200 and 900 are mechanically connected and are attachable with and detachable from each other, they are not necessarily required to be mechanically connectable, as long as the main bodies 120 and 1020 and the extension devices 200 and 900 are arranged so that the distance image sensors 201a and 201b can detect an operation on the virtual operating surface 110. For example, with the main bodies 120 and 1020 and the extension devices 200 and 900 connected electrically by wireless communications or the like, the main bodies 120 and 1020 and the extension devices 200 and 900 can be arranged so that the distance image sensors 201a and 201b can detect an operation on the virtual operating surface 110.

Although the above-described first to third embodiments have exemplified the finger P of the user as an operating part for an operation on the virtual operating surface 110, it is not a limited example. For example, a stylus pen or the like may be used as an operating part for an operation on the virtual operating surface 110.

In the above-described first and second embodiments, when the user performs a touch operation on the touch screen 11 with the main bodies 120 and 1020 and the extension devices 200 and 900 connected, it is optional whether the detection of an operation on the virtual operating surface 110 is invalid with only a touch operation on the touch screen 11 valid, or both an operation on the virtual operating surface 110 and a touch operation on the touch screen are valid.

Computer programs to be run on the information processing apparatuses 100 and 1200 of the above-described embodiments may be recorded on a computer-readable recording medium such as a CD-ROM, flexible disk (FD), CD-R, or digital versatile disk (DVD) as files in an installable form or an executable form, and provided.

The programs to be run on the information processing apparatuses 100 and 1200 of the above-described embodiments may be stored on a computer connected to a network such as the Internet and may be provided by being downloaded through the network. The programs to be run on the information processing apparatus 100 and 1200 of the above-described embodiments may be provided or distributed through a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a main body having a display screen; and
an extension device configured to be connectable with the main body, wherein
the extension device comprises a detector configured to detect an operation with an operating part performed on a virtual operating surface and output detection information on the operation, the virtual operating surface being a virtual plane spaced apart from the display screen by a predetermined distance, and
the main body comprises:
a connection detector configured to detect connection of the extension device;
a virtual input module configured to receive the detection information from the extension device when the connection of the extension device has been detected and determine a position of the operating part on the virtual operating surface based on the detection information; and
an input controller configured to perform input processing as a touch operation at the position having been determined.

2. The information processing apparatus according to claim 1, wherein
the virtual input module further determines a contact time, for which the operating part is in contact with the virtual operating surface, based on the detection information on the operation and
the input controller is configured to perform input processing as the touch operation that continues for the contact time.

3. The information processing apparatus according to claim 1, wherein
the virtual input module further determines a sectional area of the operating part crossing the virtual operating surface as a contact area with respect to the virtual operating surface, based on the detection information and
the input controller is configured to perform input processing as the touch operation with the contact area.

4. The information processing apparatus according to claim 1, wherein
the virtual input module further determines a depth from the operating part crossing the virtual operating surface from the virtual operating surface, based on the detection information, and determines a pressing force of the operation based on the depth and
the input controller is configured to perform input processing as the touch operation with the pressing force.

5. The information processing apparatus according to claim 1, wherein the extension device includes a keyboard.

6. An extension device that is connectable with an information processing apparatus having a display screen, the extension device comprising:
a detector configured to detect an operation with an operating part performed on a virtual operating surface and output detection information on the operation, the virtual operating surface being a virtual plane spaced apart from the display screen by a predetermined distance,
a virtual input module configured to determine a position of the operating part on the virtual operating surface based on the detection information; and
a transmitter configured to perform transmission as a touch operation at the position having been determined to the information processing apparatus.

7. An input control method, comprising:
detecting an operation with an operating part performed on a virtual operating surface that is a virtual plane spaced apart from a display screen by a predetermined distance;
outputting detection information on the operation;
determining a position of the operating part on the virtual operating surface based on the detection information; and
performing input processing as a touch operation at the position having been determined.
